(19) United States
(12) Patent Application Publication
(10) Pub. No.: US 2018/0322295 A1
(43) Pub. Date: Nov. 8, 2018

(54) ENCODING INFORMATION USING WORD EMBEDDING

(71) Applicant: International Business Machines Corporation, Armonk, NY (US)

(72) Inventors: Rajesh R. Bordawekar, Millwood, NY (US); Oded Shmueli, Nofit (IL)

(21) Appl. No.: 15/586,882

(22) Filed: May 4, 2017

(51) Int. Cl. G06F 21/60; G06F 21/62

(52) U.S. Cl. CPC G06F 21/602; G06F 21/6245

(57) ABSTRACT

A computer-implemented method includes receiving, by a processor system, a collection of information. The collection of information includes private information and non-private information. The method also includes producing a plurality of vectors to represent the private information and the non-private information. The plurality of vectors corresponds to encoded representations of the private information and the non-private information. The method also includes publishing at least a portion of the collection of information and the corresponding vectors.

### BACKGROUND

The present invention relates in general to encoding information using word embedding. More specifically, the present invention relates to encoding information within vector representations of the information.

Users often have private data that they desire to protect from destructive forces and unauthorized users. Users can store their private data, for example, within a document and/or within a repository such as a database. A database is generally understood as a structured collection of data that is stored and accessed by a computing device.

### SUMMARY

According to one or more embodiments of the present invention, a computer-implemented method includes receiving, by a processor system, a collection of information. The collection of information includes private information and non-private information. The method also includes producing a plurality of vectors to represent the private information and the non-private information. The plurality of vectors corresponds to encoded representations of the private information and the non-private information. The method also includes publishing at least a portion of the collection of information and the corresponding vectors.

According to one or more embodiments of the present invention, a computer system and memory are provided. The computer system also includes a processor system communicatively coupled to the memory. The processor system is configured to perform a method including receiving, by the processor system, a collection of information that includes private information and non-private information. The method also includes producing a plurality of vectors to represent the private information and the non-private information. The plurality of vectors corresponds to encoded representations of the private information and the non-private information. The method also includes publishing at least a portion of the collection of information and the corresponding vectors.

According to one or more embodiments of the present invention, a computer program product for encoding using word embedding is provided. The computer program product includes a computer-readable storage medium that has program instructions embodied therewith. The program instructions are readable by a processor system to cause the processor system to perform a method that includes receiving, by the processor system, a collection of information. The collection of information includes private information and non-private information. The method also includes producing, by the processor system, a plurality of vectors to represent the private information and the non-private information. The plurality of vectors corresponds to encoded representations of the private information and the non-private information. The method also includes publishing at least a portion of the collection of information and the corresponding vectors.

### BRIEF DESCRIPTION OF THE DRAWINGS

The subject matter of the present invention is particularly pointed out and distinctly defined in the claims at the conclusion of the specification. The foregoing and other features and advantages are apparent from the following detailed description taken in conjunction with the accompanying drawings in which:

FIG. 1. illustrates an example d-dimension vector representation that has been produced for an example word, in accordance with one or more embodiments of the present invention;

FIG. 2 illustrates a database table that includes information to be encoded, in accordance with one or more embodiments of the present invention;

FIG. 3 illustrates a database table with encrypted information to be encoded, in accordance with one or more embodiments of the present invention;

FIG. 4 illustrates word-vector pairs, in accordance with one or more embodiments of the present invention.

FIG. 5 depicts a flowchart of a method in accordance with one or more embodiments of the present invention;

FIG. 6 depicts a high-level block diagram of a computer system, which can be used to implement one or more embodiments; and

FIG. 7 depicts a computer program product, in accordance with an embodiment of the present invention.

### DETAILED DESCRIPTION

In accordance with one or more embodiments of the invention, methods and computer program products for encoding information using word embedding are provided. Various embodiments of the present invention are described herein with reference to the related drawings. Alternative embodiments can be devised without departing from the scope of this invention. References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Additionally, although this disclosure includes a detailed description of a computing device configuration, implementation of the teachings recited herein are not limited to a particular type or configuration of computing device(s). Rather, embodiments of the present disclosure are capable of being implemented in conjunction with any other type or configuration of wireless or non-wireless computing devices and/or computing environments, now known or later developed.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

For the sake of brevity, conventional techniques related to computer processing systems and computing models may or may not be described in detail herein. Moreover, it is understood that the various tasks and process steps described herein can be incorporated into a more comprehensive procedure, process or system having additional steps or functionality not described in detail herein.

“Word embedding” produces a d-dimension vector for each word of a document and/or collection of information, and associates each word with its corresponding d-dimension vector. A d-dimension vector {v₁, v₂, v₃, v₄ . . . , v_{d}} can be considered to be a vector with a “d” number of values. Each vector can include a series of real numbers, as described in more detail below. The vector of a word can be an encoded representation of the word's meaning.

The meaning of a specific word (as represented by the word's vector) can be based at least on one or more other words that neighbor the specific word within the document/collection. Specifically, the words that neighbor the specific word can provide context to the specific word, and the neighboring words constitute a neighborhood of the specific word. The d-dimension vector of the specific word can be an aggregation of contributions from neighboring words towards the meaning of the specific word.

The d-dimension vector of each word can provide insights into the meaning of the specific word, especially when the vector is represented as a point in d-dimensional space. The relative positioning of each word's vector representation, within the d-dimension space, will reflect the relationships that exist between the words. For example, if two words have similar meanings, then the vector representations of the two words will appear relatively close to each other, or the vector representations of the two words will point in a similar directionality, when positioned in the d-dimensional space.

For example, if the vector representation of the word “CAT” and the vector representation of the word “KITTEN” are both positioned in d-dimension space, the vector representations will appear relatively close to each other, or the vector representations will point in a similar direction, because a logical relationship exists between the word “CAT” and the word “KITTEN.” If the vector representations of the two words appear in close proximity to each other in the d-dimensional space (or point in a similar directionality in the d-dimensional space), then a logical relationship between these two words can be inferred.

In order to produce a vector representation of a word, embodiments of the invention can use one or more word-embedding model-producing programs. For example, embodiments of the invention can use one or more neural networks to perform word embedding. Embodiments of the invention can use model-producing programs such as, for example, Word2vec to produce a model in the form of vector representations. Embodiments of the invention can also use model-producing programs such as GloVe, to produce the model in the form of vector representations. In order to produce a vector representation of a specific word within a document/collection, the neighborhood of the specific word is inputted into the one or more model-producing programs. For example, the sentences of the document/collection can be inputted into the model-producing program to produce a vector representation of the specific word that is based at least upon the inputs.

One or more embodiments of the invention can use word embedding to encode both private information and non-private information of a database. For example, one or more embodiments can use word embedding to encode the private information and non-private information into corresponding vector representations. If a manager of the database decides to share the non-private information while hiding the private information, the manager can publish only the non-private information to a recipient user. As such, the recipient user can view the words/values of the non-private information as well the corresponding vector representations of the non-private words/values. Although the words/values of the private information are not published by the manager (and thus are not viewable by the recipient user), the recipient user can still access latent relational information that reflects the relations between the non-private information and the private information. The recipient user can access the latent relational information because the vector representations of the non-private words/values were generated using the private words/values. Specifically, the private words/values were inputted into the model-producing programs to generate the vector representations of the non-private words/values. Thus, embodiments of the present invention enable a manager to share latent relational information to a recipient user while also allowing the manager to hide the actual private words/values from the recipient user, as described in more detail below.

FIG. 1 illustrates an example d-dimension vector representation that has been produced for an example word, in accordance with one or more embodiments of the present invention. In FIG. 1, an example vector representation 110 has been produced for the example “John_Adams” word. Vector representation 110 is a d-dimension vector that includes a series of real numbers.

As described above, vector representations can provide insights into the meanings of their corresponding words. By producing vector representations of words/information that are stored within a database table (where a database table can include a plurality of rows and a plurality of columns), one or more embodiments of the invention can enable users to access latent information that is present within the relations expressed within the database table. Such information can be in the form of information relating to inter-column and intra-column relationships, for example. By producing vector representations of words/information, embodiments of the invention can allow users to access the latent information by enabling semantic queries of the database, for example.

In addition to providing the benefit of access to the above-described latent information, one or more embodiments of the invention can also use vector representations as a way to encode information. Specifically, one or more embodiments of the invention can encode information in order to maintain the privacy of the information, as described in more detail below.

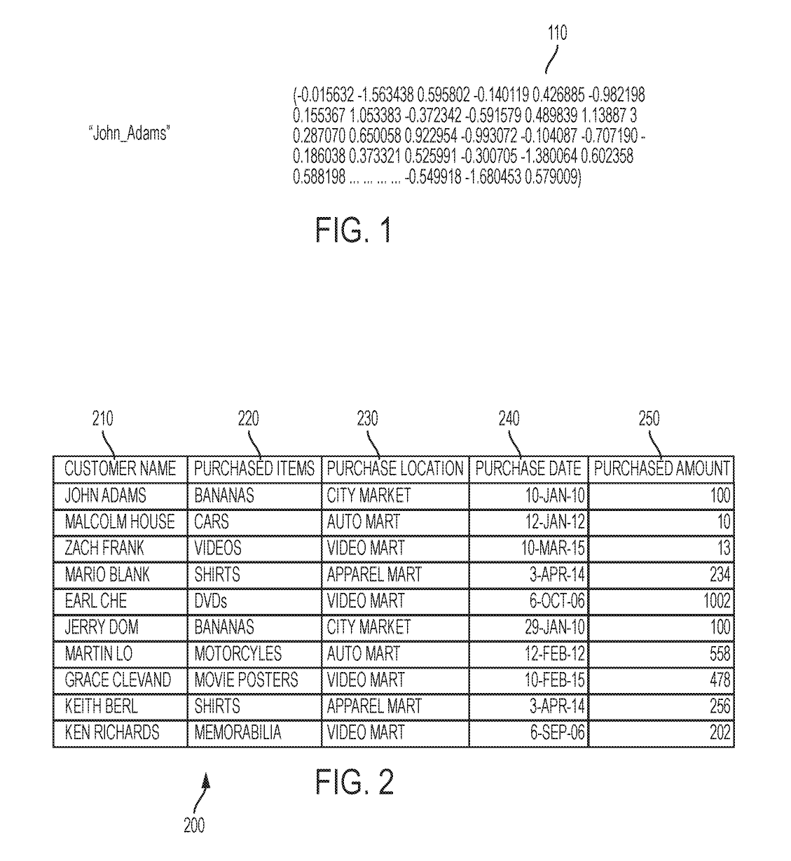

For example, in accordance with one or more embodiments of the invention, a database table can include private information. FIG. 2 illustrates a database table 200 that includes information to be encoded, in accordance with one or more embodiments of the present invention. Referring to FIG. 2, database table 200 includes information relating to customer transactions, where column 210 includes information corresponding to a “customer name,” where column 220 includes information corresponding to a “purchased item” that has been purchased by the customer indicated in column 210, where column 230 includes information corresponding to a “purchase location,” where column 240 includes information corresponding to a “purchase date,” and where column 250 includes information corresponding to a “purchased amount.” In the example of FIG. 2, some or all of the information of database table 200 can be private information. For example, the private information can be information that is contained within a particular column/row, and/or the private information can be expressed by the relative arrangement of the columns/rows.

As described above, embodiments of the present invention can maintain the privacy of information by producing vector representations of the information, where the vector representations encode the represented information. In order to produce vector representations for the words/information within database table 200, one or more embodiments of the invention can input one or more portions of the information contained within database table 200 into a word-embedding model-producing program (i.e., word2vec and/or GloVe, for example).

As described above, the computing system of one or more embodiments of the present invention can train a word-embedding model-producing program. With a database, one or more embodiments can train the model-producing program using the entire database or a subset of the database. In one example embodiment, the word-embedding model-producing program can be trained using clear-text versions of the values of the database. In another example embodiment, values of the database can be encrypted before training the model-producing program. With this example embodiment, the model-producing program can be trained with the encrypted values.

For example, the information contained within each row of database table 200 can be input into the word-embedding model-producing program. For example, one or more embodiments of the invention can consider the words/information of each row (of database table 200) as corresponding to a sentence of neighboring words that is to be input into the word-embedding model-producing program. Therefore, the words/information contained within the rows can be considered to be sentences within a document/collection, which can be inputted into the one or more word-embedding model-producing programs for producing a vector representation for each word. With one or more embodiments of the invention, if a plurality of words exist within a single database table entry (such that the words are associated with a same logical entity), the plurality of words can be combined into a single word. For example, the separate words “John” and “Adams” occupy a same database table entry in column 210, and thus the two words describe a single customer name “John_Adams.” The two words can be combined using underscores or hyphens, for example.

Referring to the first row of database table 200, one example sentence of neighboring words, which can be inputted into the one or more model-producing programs, can be “John_Adams Bananas City_Market 10-Jan-10 100.” Referring to the second row of database table 200, another example sentence which can be inputted into the one or more model-producing programs can be “Malcolm_House Cars Auto_Mart 12-Jan-12 10.” These example sentences can be used to generate vector representations for each word that is stored in database table 200.

One or more embodiments of the invention can further ensure the privacy of private information by not inputting the private information into the word-embedding model-producing programs, when producing the vector representations. For example, referring again to FIG. 2, suppose that the names of column 210 (“Customer name”) is the private information. One or more embodiments of the invention can exclude these names from being input into the word-embedding model-producing programs when producing the vector representations. With this embodiment, referring to the first row of database table 200, one example sentence which can be inputted into the one or more model-producing programs can be “Bananas City_Market 10-Jan-10 100.” Referring to the second row of database table 200, another example sentence which can be inputted can be “Cars Auto_Mart 12-Jan-12 10.” As such, by not inputting the private information into the word-embedding model-producing programs, the private information is further protected.

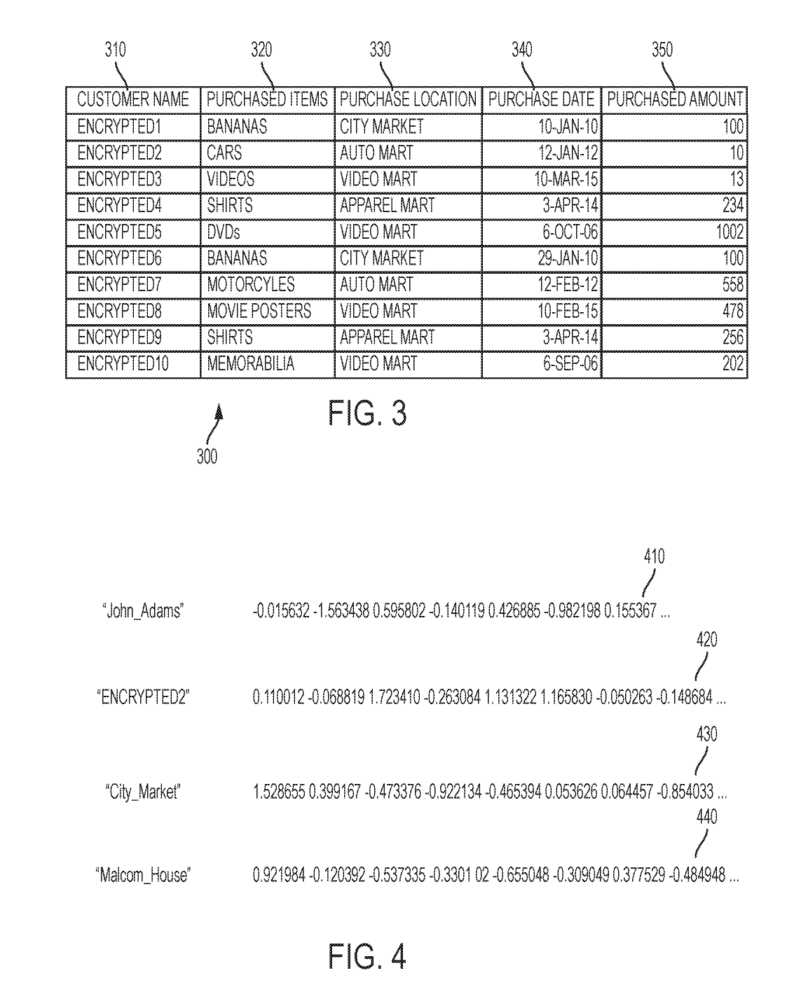

One or more embodiments of the invention can further ensure the privacy of private information by encrypting the private information. FIG. 3 illustrates a database table 300 with encrypted information to be encoded in accordance with one or more embodiments of the present invention. In this example, at least some of the information in columns 310-350 will be encoded. Encrypted private information can also be inputted into the word-embedding model-producing program, when producing vector representations. With this embodiment, referring to the first row of database table 300, one example sentence which can be inputted into the one or more model-producing programs can be “Encrypted1 Bananas City_Market 10-Jan-10 100.” Referring to the second row of database table 300, another example sentence which can be inputted can be “Encrypted2 Cars Auto_Mart 12-Jan-12 10.” As such, by encrypting the private information before inputting the sentences into the model-producing programs, the private information is further protected.

As described above, one or more embodiments of the invention can use word embedding to create vector representations of words within a document/collection, in order to encode the information of the document/collection. After producing the vector representations, embodiments of the invention can express the information of the document/collection in the form of word-vector pairs.

FIG. 4 illustrates word-vector pairs, in accordance with one or more embodiments of the present invention. As representative vectors are produced for the words/information of database table 300, each representative vector is associated with its corresponding word/information. For example, “John_Adams” can be associated with representative vector 410, to form a word-vector pair. As another example, “Encrypted2” can be encrypted private information that is paired with representative vector 420. As another example, “City_Market” can be associated with representative vector 430. As another example, “Malcolm_House” can be associated with representative vector 440. One or more embodiments of the invention may then transmit the word-vector pairs to recipient users.

As described above, a managing user that manages a database table can decide that a recipient user should receive and view only a specific portion of the entire database table. For example, a managing user of database table 200 can decide that only certain non-private columns, rows, and/or entries should be received/viewed by the recipient user. For example, if the managing user decides that customer names (of column 210) is considered private and should be hidden from the recipient user, the managing user can decide to publish only non-private columns 220-250 of database table 200 to the recipient user, without publishing private “Customer Name” column 210. Therefore, when viewing database table 200, the recipient user is only able to view non-private published columns 220-250, and the private customer names (of column 210) are thus hidden from the recipient user.

When non-private columns 220-250 are published to the recipient user, the recipient user will be able to view the database words/values of columns 220-250 and will also be able to view the corresponding vector representations of these database words/values. As described above, the vector representations (corresponding to the non-private words/values of columns 220-250) can be previously generated by inputting, at least, words/values of column 210 into a model-producing program. Therefore, although the recipient user will not be able to view the private database words/values of “Customer Name” column 210, the recipient user can still be able to access/utilize latent relational information that reflects the relationship between the private words/values of column 210 and the non-private words/values of columns 220-250. The recipient user can still be able to access this latent relational information because this information is reflected within the viewable vector representations (corresponding to the non-private words/values of columns 220-250). Therefore, embodiments of the present invention allow a managing user to hide database words/values from a recipient user while also sharing relational information (between the hidden words/values and the non-hidden words/values) via the vector representations of the non-hidden words/values. The recipient can perform filtering of the published data using structured query language (SQL).

With one or more embodiments, a managing user can choose which portion of the database data to input into a model-producing program to generate vector representations of the database data. The managing user can also choose which portions of the database data should be published to the recipient user. The publisher of the data words/values and associated vectors can also use SQL to limit the words/values that are inputted into a model-producing program.

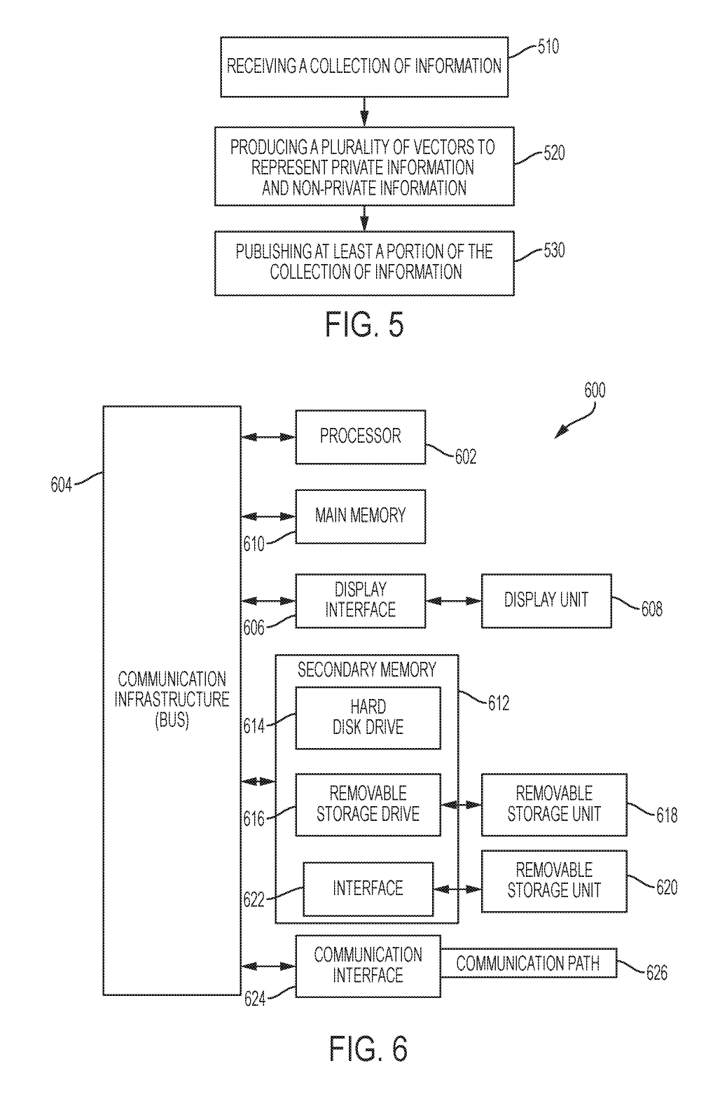

FIG. 5 depicts a flowchart of a method in accordance with one or more embodiments of the present invention. The method includes, at 510, receiving, by a processor system, a collection of information. The collection of information includes private information and non-private information. The method also includes, at 520, producing a plurality of vectors to represent the private information and the non-private information. The plurality of vectors corresponds to encoded representations of the private information and the non-private information. The method also includes, at 530, publishing at least a portion of the collection of information and the corresponding vectors.

FIG. 6 depicts a high-level block diagram of a computer system 600, which can be used to implement one or more embodiments of the invention. Computer system 600 can be used to implement hardware components of systems capable of performing methods described herein. Although one exemplary computer system 600 is shown, computer system 600 includes a communication path 626, which connects computer system 600 to additional systems (not depicted) and can include one or more wide area networks (WANs) and/or local area networks (LANs) such as the Internet, intranet(s), and/or wireless communication network(s). Computer system 600 and additional system are in communication via communication path 626, e.g., to communicate data between them.

Computer system 600 includes one or more processors, such as processor 602. Processor 602 is connected to a communication infrastructure 604 (e.g., a communications bus, cross-over bar, or network). Computer system 600 can include a display interface 606 that forwards graphics, textual content, and other data from communication infrastructure 604 (or from a frame buffer not shown) for display on a display unit 608. Computer system 600 also includes a main memory 610, preferably random access memory (RAM), and can also include a secondary memory 612. Secondary memory 612 can include, for example, a hard disk drive 614 and/or a removable storage drive 616, representing, for example, a floppy disk drive, a magnetic tape drive, or an optical disc drive. Hard disk drive 614 can be in the form of a solid state drive (SSD), a traditional magnetic disk drive, or a hybrid of the two. There also can be more than one hard disk drive 614 contained within secondary memory 612. Removable storage drive 616 reads from and/or writes to a removable storage unit 618 in a manner well known to those having ordinary skill in the art. Removable storage unit 618 represents, for example, a floppy disk, a compact disc, a magnetic tape, or an optical disc, etc. which is read by and written to by removable storage drive 616. As will be appreciated, removable storage unit 618 includes a computer-readable medium having stored therein computer software and/or data.

In alternative embodiments of the invention, secondary memory 612 can include other similar means for allowing computer programs or other instructions to be loaded into the computer system. Such means can include, for example, a removable storage unit 620 and an interface 622. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 620 and interfaces 622 which allow software and data to be transferred from the removable storage unit 620 to computer system 600.

Computer system 600 can also include a communications interface 624. Communications interface 624 allows software and data to be transferred between the computer system and external devices. Examples of communications interface 624 can include a modem, a network interface (such as an Ethernet card), a communications port, or a PC card slot and card, a universal serial bus port (USB), and the like. Software and data transferred via communications interface 624 are in the form of signals that can be, for example, electronic, electromagnetic, optical, or other signals capable of being received by communications interface 624. These signals are provided to communications interface 624 via communication path (i.e., channel) 626. Communication path 626 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 610 and secondary memory 612, removable storage drive 616, and a hard disk installed in hard disk drive 614. Computer programs (also called computer control logic) are stored in main memory 610 and/or secondary memory 612. Computer programs also can be received via communications interface 624. Such computer programs, when run, enable the computer system to perform the features discussed herein. In particular, the computer programs, when run, enable processor 602 to perform the features of the computer system. Accordingly, such computer programs represent controllers of the computer system. Thus it can be seen from the forgoing detailed description that one or more embodiments of the invention provide technical benefits and advantages.

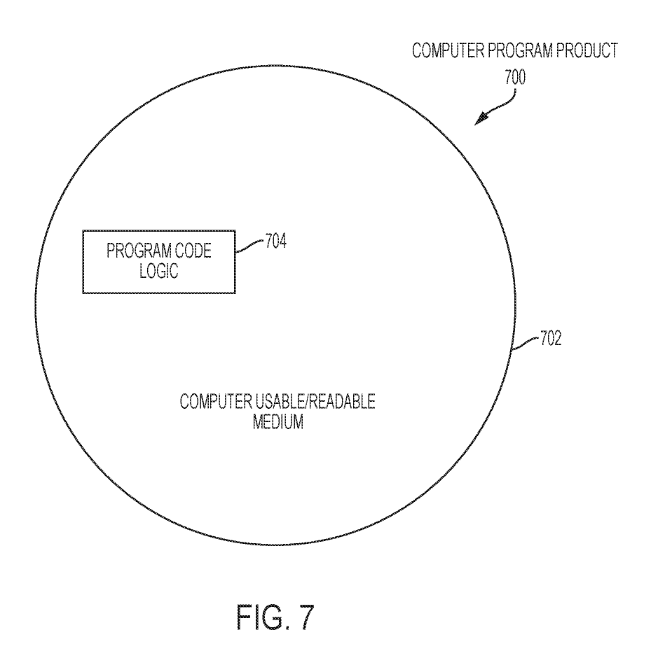

FIG. 7 depicts a computer program product 700, in accordance with an embodiment of the present invention. Computer program product 700 includes a computer-readable storage medium 702 and program instructions 704.

Embodiments of the invention can be a system, a method, and/or a computer program product. The computer program product can include a computer-readable storage medium (or media) having computer-readable program instructions thereon for causing a processor to carry out aspects of embodiments of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform embodiments of the present invention.

Aspects of various embodiments are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments described herein.

What is claimed is:

1. A computer implemented method comprising:
receiving, by a processor system, a collection of information comprising private information and non-private information;
producing a plurality of vectors to represent the private information and the non-private information, wherein the plurality of vectors corresponds to encoded representations of the private information and the non-private information; and
publishing at least a portion of the collection of information and the corresponding vectors.

2. The computer implemented method of claim 1, wherein each vector corresponds to an encoded representation of a word within the information.

3. The computer implemented method of claim 1, wherein the producing comprises producing a plurality of d-dimensional vectors.

4. The computer implemented method of claim 1, wherein the producing comprises inputting at least a portion of the collection of information into a word embedding model-producing program.

5. The computer implemented method of claim 4, wherein the inputted portion comprises private and non-private information.

6. The computer implemented method of claim 1, wherein the private information is encrypted.

7. The computer implemented method of claim 1, wherein the publishing comprises transmitting pairings of vectors and words of the information.

8. A computer system comprising:
a memory; and
a processor system communicatively coupled to the memory;
the processor system configured to perform a method comprising:
receiving, by a processor system, a collection of information comprising private information and non-private information;
producing a plurality of vectors to represent the private information and the non-private information, wherein the plurality of vectors corresponds to encoded representations of the private information and the non-private information; and
publishing at least a portion of the collection of information and the corresponding vectors.

9. The computer system of claim 8, wherein each vector corresponds to an encoded representation of a word within the information.

10. The computer system of claim 8, wherein the producing comprises producing a plurality of d-dimensional vectors.

11. The computer system of claim 8, wherein the producing comprises inputting at least a portion of the collection of information into a word embedding model-producing program.

12. The computer system of claim 11, wherein the inputted portion comprises private and non-private information.

13. The computer system of claim 8, wherein the private information is encrypted.

14. The computer system of claim 8, wherein the publishing comprises transmitting pairings of vectors and words of the information.

15. A computer program product for encoding using word embedding, the computer program product comprising a computer-readable storage medium having program instructions embodied therewith, the program instructions readable by a processor system to cause the processor system to:
receive, by the processor system, a collection of information comprising private information and non-private information;
produce, by the processor system, a plurality of vectors to represent the private information and the non-private information, wherein the plurality of vectors corresponds to encoded representations of the private information and the non-private information; and
publish at least a portion of the collection of information and the corresponding vectors.

16. The computer program product of claim 15, wherein each vector corresponds to an encoded representation of a word within the information.

17. The computer program product of claim 15, wherein the producing comprises producing a plurality of d-dimensional vectors.

18. The computer program product of claim 15, wherein the producing comprises inputting at least a portion of the collection of information into a word embedding model-producing program.

19. The computer program product of claim 18, wherein the inputted portion comprises private and non-private information.

20. The computer program product of claim 15, wherein the private information is encrypted.
